(19) United States
(12) Patent Application Publication
(10) Pub. No.: US 2012/0047072 A1
(43) Pub. Date: Feb. 23, 2012

(54) MERCHANT ALERT SYSTEM AND METHOD FOR FRAUD PREVENTION

(75) Inventor: Colin Larkin, Dundrum (IE)

(73) Assignee: MOQOM LIMITED, Dublin (IE)

(21) Appl. No.: 13/202,525

(22) PCT Filed: Feb. 19, 2010
(86) PCT No.: PCT/IE2010/000008

§ 371 Date: Nov. 7, 2011

(30) Foreign Application Priority Data
Feb. 20, 2009 (IE) S2009/0139

(51) Int. Cl. G06Q 20/08

(52) U.S. Cl. 705/44

(57) ABSTRACT

A system and method for preventing merchant electronic transaction fraud includes a plurality of network connected data processing terminals, including at least one server; means for receiving an electronic authorisation request at the server from a first data processing terminal, the request is for authorising the processing of an electronic transaction associated with a cardholder's card or account data; means for filtering the received request according to predetermined filtering criteria; means for identifying at least a second data processing terminal as a merchant device; means for sending the request to the merchant device, to notify the merchant that processing of an electronic transaction is proposed, a parameter of which is said cardholder's card or account data and alert data to indicate that the transaction is fraudulent; and means for receiving interrupt data from the second terminal and for interrupting processing of the transaction with that card data or account data.

### FIELD OF THE INVENTION

The invention relates to fraud prevention. In particular the invention relates to a system and method for merchant credit/debit card fraud prevention and customer credit/debit card fraud prevention.

### BACKGROUND TO THE INVENTION

Card fraud is an ever increasing problem for financial institutions such as credit card companies, merchants and banks. The introduction of chip and PIN technology in recent years was aimed at eliminating such crime. Although card fraud in certain areas has seen a decline, other fraud in other areas has increased significantly. Examples of various types of card fraud are:

### Card-Not Present (CNP)

Card-not present (CNP) refers to internet, phone and mail order fraud. This happens when card details are stolen to pay for services and goods over the phone, internet or by mail order. The main problem to fight this fraud is that the card holder is not present and does not know anything about the fraud until well after the fraud has been committed as the statement is checked at a later stage. In addition as the merchant supplying the goods and/or services does not realise a fraudulent transaction is taking place the merchant delivers the goods and can thus liable for the financial value of the transaction.

### Counterfeit Fraud

Counterfeit Fraud refers to when fraudsters copy the magnetic stripe details and create fake replicas of the card. These counterfeit cards are generally used abroad where chip and PIN technology is yet to be introduced.

### Lost and Stolen Card Fraud

Lost and stolen card fraud refers to fraud using cards that have been reported lost or stolen by the cardholder. Most Lost and stolen card fraud takes place in shops that are yet to introduce chip and PIN equipment. As the fraudster does not require a PIN and can therefore use the card before the cardholder has reported the card lost or stolen. Some programs are in place to counteract this, like analysing customer accounts for unusual spending patterns. The lost and stolen card fraud has gone down in recent years.

### Mail Non-Receipt Fraud

Mail non-receipt fraud refers to fraud involving cards that were stolen after card companies issue them and before the cardholders receive them. This can typically take place in apartment buildings or in situations where the cardholder does not redirect their mail. This fraud has also been in decline in recent years due to the fact that fewer cards are issued and also because the cardholder already has the PIN, so a new PIN is not issued.

### Card ID Theft

Card ID theft refers to when a criminal uses a fraudulently obtained card or card details, along with stolen personal information, to open or take over a card account in someone else's name. There are two types:

1. Application fraud is when criminals make use of stolen or fake documents to open an account in someone else's name. Criminals may try to steal documents such as utility bills and bank statements to build up useful personal information, or they may use counterfeited documents for identification purposes; and
2. Account take-over is when a criminal will attempt to take over another person's account, first by gathering information about the intended victim, then, contacting their bank or credit card issuer whilst masquerading as the genuine cardholder. The criminal can then transfer funds out of the account or can change the address on the account and ask for new or replacement cards to be sent to the changed address.

ATM Fraud is carried out by criminals by copying the magnetic stripes of the cards and records the PINs while the cardholders were using the cash machines. There are a couple of ways this can be done:
Shoulder surfing is where criminals look over the cardholders shoulder to obtain the PIN and then later steal the card using some sort of distraction technique.
Card-tapping device's is where a criminal would insert a device into the card machines card slot that retains the card. The criminal would then trick the card holder to enter the PIN again. When the card holder leaves, the criminal would steal the card and use the obtained PIN to withdraw cash.
Skimming from the magnetic stripe at cash machines (ATMs) is where the criminals attach a skimming device to the cash machine to record the electronic details from the magnetic stripe of genuine cards as they are inserted into the cash machine and a miniature camera is hidden overlooking the PIN pad to capture the PIN being entered. Criminals will then use the obtained data to produce fake magnetic stripes and use the genuine PIN to withdraw money from cash machines overseas.

Due to the introduction of chip and PIN, criminals are targeting the environments where chip and PIN are not yet used, like the interne and abroad. Areas like merchant/retailer fraud have declined due to the introduction of chip and PIN. However fraudulent Card Not Present transactions are on the increase. Card Not Present (CNP) fraud is a massive problem for merchants and they are often forced to take full responsibility for this kind of fraud.

Card fraud is an escalating problem covering all areas of financial transactions, which ultimately affects financial institutions such as banks, payment service providers and end supplier merchants in addition to causing major distress to the cardholder. A number of different systems have already been introduced by the industry to try to eliminate such card crimes, for example chip & PIN and intelligent fraud detection software. A system for preventing customer fraud is described in PCT application number PCT/IE2009/000088, assigned to Moqom Limited, however a problem remains for informing merchants of fraudulent or potential fraudulent transactions.

Using these systems some card transactions are halted immediately while others transactions are flagged as potentially fraudulent, i.e. disputed transactions information regarding potentially fraudulent transactions is rarely sent to merchants or sent weeks later making it too late to retrieve the goods or service when a fraud is discovered.

The main problem for merchants is that they do not know until well after the event when a fraudulent transaction takes place. Merchants would benefit significantly from receiving quicker feedback regarding potentially fraudulent transactions.

It is therefore an object of the invention to provide a merchant fraud prevention system and method to overcome the above mentioned problems.

### SUMMARY OF THE INVENTION

According to the invention there is provided, as set out in the appended claims, a method and system for preventing merchant electronic transaction fraud, comprising:
a plurality of network connected data processing terminals, including at least one server;
means for receiving an electronic authorisation request at the server from a first data processing terminal, wherein the request is for authorising the processing of an electronic transaction associated with a cardholder's card data or account data;
means for filtering the received request according to predetermined filtering criteria;
means for identifying at least a second data processing terminal as a merchant device;
means for sending the request to the merchant device, to notify the merchant that processing of an electronic transaction is proposed, a parameter of which is said cardholder's card data or account data and alert data to indicate that the electronic transaction is fraudulent; and
means for receiving interrupt data from the second terminal and for interrupting processing of the, or any further, electronic transaction with that card data or account data.

In one embodiment there is provided means for sending the request to a device associated with the cardholder to notify the card holder that an electronic transaction is about to take place.

In one embodiment the alert data comprises means for sending instructions to block the electronic transaction received by the server from the card holder to a particular merchant.

In one embodiment the first data processing terminal data and the server are connected by a first network, and the second data processing terminal data and the server are connected by the first or a second network.

In one embodiment said alert data is transmitted on a unique channel to the merchant, to notify the merchant of a suspected fraudulent transaction.

In one embodiment the alert data can be transmitted using a number of different communication protocols, such as HTTP, POST, SMS, WAP or email.

In one embodiment there is provided means to store inputs from multiple fraud detection systems with previous fraudulent transactions such as those in acquiring banks, card associations, issuing banks, payment service providers or merchants for subsequent comparison with a request for an electronic transaction.

In one embodiment the first or second network is selected from the group comprising a public switched telephone network, a cellular telecommunication network, a wide area network, a local area network, a wireless local area network, a virtual private network and an interbank network.

In one embodiment the first data processing terminal is selected from the group comprising an electronic point of sale terminal, an electronic card processing terminal, an automatic teller machine, a telephone, a cellular telephone, a radiotelephone, a portable computing device, a desktop computing device.

In one embodiment the at least second data processing terminal is selected from the group comprising a telephone, a cellular telephone, a radiotelephone, a pager, a personal digital assistant, a portable computing device, a desktop computing device.

In one embodiment there is provided means for identifying the at least second data processing terminal comprises a database storing at least, for each merchant associated with a network address of at least a second data processing terminal.

In one embodiment there is provided means for identifying is adapted to identify a plurality of data processing terminals as respective devices of a same merchant.

In one embodiment there is provided means for filtering the received request according to predetermined filtering criteria comprises a filter engine.

In one embodiment the predetermined filtering criteria is selected from data representative of any one, or a combination, of the group comprising a mandatory notification, an optional notification, a transaction amount threshold, a geographical position, a first data processing terminal type, a network type, a financial institution identifier, a merchant identifier.

In one embodiment the means for sending the request to the merchant device comprises any one, or a combination, selected from the group comprising messaging instructions stored and processed by the at least one server, a cellular messaging server, an interactive voice response apparatus.

In one embodiment the means for receiving interrupt data from the second terminal and interrupting processing of the electronic transaction comprises a combination of at least one selected from the group comprising messaging instructions stored and processed by the at least one server, a cellular messaging server and an interactive voice response apparatus, respectively receiving the interrupt data from the at least second terminal, and a transaction processing terminal.

In one embodiment the interrupt data is any one, or a combination, selected from the group comprising a portion of card data, a portion of account data, a personal identification number, alphanumerical data representative of a user decision, digitized audio data representative of a user decision, a predetermined period of time.

In one embodiment the plurality of network connected data processing terminals includes at least one security terminal operated by a state, official or private security organisation.

In one embodiment there is provided means to automatically communicate interrupt data to the security terminal, whenever interrupt data is received from a second terminal for an electronic transaction.

In one embodiment there is provided means to automatically communicate further comprises aggregating means for receiving the interrupt data and generating fraud reporting data.

In one embodiment the fraud reporting data corresponds to at least one selected from the group comprising a geographical position, a first data processing terminal type, a financial institution identifier, a merchant identifier, image data, audio data and video data, as a function of whether any such data is stored at the first data processing terminal and/or at the server in connection with the reported transaction.

In one embodiment the fraud reporting data corresponds to a combination of some or all of data corresponding to a geographical position, a first data processing terminal type, a financial institution identifier, a merchant identifier, image data, audio data and/or video data, as a function of whether any such data is stored at the first data processing terminal and/or at the server in connection with the reported transaction.

In one embodiment the at least one security terminal is selected from the group comprising a telephone, a cellular telephone, a radiotelephone, a pager, a personal digital assistant, a portable computing device, a desktop computing device, a personal radio, a two-way radio, a mobile radio or computing device aboard a land vehicle, aircraft or ship, or a combination thereof.

In another embodiment of the present invention there is provided a system for preventing merchant electronic transaction fraud, comprising:
a plurality of network connected data processing terminals, including at least one server;
means for receiving an electronic authorisation request at the server from a first data processing terminal, wherein the request is for authorising the processing of an electronic transaction associated with a cardholder's card data or account data;
means for filtering the received request according to predetermined filtering criteria;
means for identifying at least a second data processing terminal as a merchant device;
means for sending the request to the merchant device, to notify the merchant that processing of an electronic transaction is proposed, a parameter of which is said cardholder's card data or account data and alert data to indicate that the electronic transaction is fraudulent;
means for sending the request to a device associated with the cardholder to notify the card holder that an electronic transaction is about to take place; and
means for receiving interrupt data from the second terminal and for interrupting processing of the, or any further, electronic transaction with that card data or account data.

In a further embodiment there is provided a method for preventing merchant electronic transaction fraud, comprising:
arranging a plurality of network connected data processing terminals, including at least one server, in a communication network;
receiving an electronic authorisation request at the server from a first data processing terminal, wherein the request is for authorising the processing of an electronic transaction associated with a cardholder's card data or account data;
filtering the received request according to predetermined filtering criteria;
identifying at least a second data processing terminal as a merchant device;
sending the request to the merchant device, to notify the merchant that processing of an electronic transaction is proposed, a parameter of which is said cardholder's card data or account data and alert data to indicate that the electronic transaction is fraudulent; and
receiving interrupt data from the second terminal and for interrupting processing of the, or any further, electronic transaction with that card data or account data.

Merchant Alert will receive charged back transactions from an acquiring bank, issuing bank or system as described in PCT application number PCT/IE2009/000088 and store the details in the database. The merchant can then receive alerts of disputed transactions and login to the Merchant Alert Website to view the details.

According to the present invention there is provided a fraud prevention system comprising: means for receiving a request at a server to notify/authorise a transaction associated with a users card or account details; means for filtering the request by validating the request; means for sending the request to a mobile device, for example a mobile phone, belonging to said user to notify the user that a transaction is about to take place in connection with said users card or account details.

In one embodiment the invention provides a merchant alert comprising means for sending the blocking an event received by the system from the card holder to the particular merchant where the transaction took place. Alerts can be handled per merchant only alerts referring to the particular merchant are sent to the merchant. A copy can be sent to acquirers and when applicable to the payment service providers. This allows the merchant to choose between investigating the transaction further and if needed cancel the order immediately before it ever leaves the store/warehouse. This is especially advantageous feature of the invention to counter Card Not Present (CNP) fraud, for example purchases over the interne.

In one embodiment the Merchant Alert offers a unique channel to the merchant, to notify the merchant of suspected fraudulent transaction.

In one embodiment the invention supports different notification methods, for example: HTTP, POST, SMS, WAP, e-mail or similar notification methods.

In one embodiment the electronic transaction relates to the purchase of goods and/or services from a merchant.

The Merchant Alert (MA), according to the invention, essentially acts as an aggregator of fraud information taking inputs from multiple fraud detection systems such as those in acquiring banks, card associations, issuing banks, payment service providers or indeed in the future perhaps from other merchants. This fraud information can also be received by Merchant Alert from the acquiring banks in excel spreadsheets as E-mail attachments.

When the potential fraudulent transaction has been registered Merchant Alert structures the information and advises the merchants in a timely, secure and coherent manner to enable each to identify, manage and eliminate fraudulent activity.

The merchant can choose how the critical information will be presented to best suit their requirements. Some merchants have automated systems for fraud purposes and can interface directly to the Merchant Alert system. For other merchants, alerts are notified either via E-mail or SMS, and the merchant may view details by securely logging into the system via a web browser.

It one embodiment the Merchant Alert of the present invention is a hosted monitoring service; banks and merchants do not need to install anything in their networks. The solution is highly optimised with a solid plug-in architecture upon which additional features can be easily built. Such a plug-in architecture allows Merchant Alert to easily adapt to an individual customer's requirements.

Multiple merchants can register to the service and each is handled securely and separately from each other. It should be noted that merchants only receive a feed of disputed transactions that belong to them. For example, a payment is made to a merchant for some goods or services. If this transaction is disputed or charged back, Merchant Alert will return information to this merchant on this transaction only. Other merchants will not receive the alert on this transaction.

The best individual to identify fraud on a user's credit card is the cardholder's themselves. The system and method of the invention will enable the card holder to receive a notification for any transaction on the card holder's card as it happens in real time. The system will contain the card holder's mobile phone number.

In a further embodiment of the Merchant Alert the notification is sent as a SMS message and contains information about the value of the transaction and the location of the transaction, in addition to an option to block the card for future usage to prevent further card fraud. It will be appreciated that the notification message can be other types of electronic communications, for example e-mail. The notification also contains a codeword and an authentication number that together with the cardholder's mobile number makes it possible to block the card.

In combination with Merchant Alert the cardholder can receive a notification. An example of a notification received by the card holder after a transaction has taken place, according to the present invention could be; “ε350 has been debited from your VISA card at <name of terminal>, <name of location>. Reply with “block 1234” or call phone number> if this debit should not have occurred”. As you can see from the example message, the user or the card holder has two options to block the card for future usage:
1. Reply to the SMS message with the codeword, e.g. “block” and the authentication number, e.g. “1234”. The system in question will receive this message and forward the blocking request to the card organisation's card system that will in turn block the card for future usage. The card holder will then receive a confirmation that the card is blocked for future usage.
2. Call the <phone number> received in the notification. When calling this number, the call will be routed to an IVR which will handle the blocking request automatically. The card holder will be asked by the IVR to say the codeword and the authentication number. The IVR will then reply to the system with the appropriate action which will then forward the request to the card organisation's card system, which will in turn block the card for future usage. If the IVR fails to understand the card holder, the call will be routed to a customer care person in the card organisation.

According to another embodiment of the present invention there is provided a method of replying to a notification using a SMS message containing a codeword and authentication code to automatically block a card holder's card for future usage and remove any exposure of card fraud. The card holder will also receive a notification from the system to be informed that the card has been blocked from future usage.

In addition, for the card holder to replying to a text to block the card, to add functionality where a card holder can also can receive two additional types of notifications:

1. The system can send a WAP Push message to the card holders phone and the card holder can click on the WAP message to block the card. This makes it easier to use for the card holder. This method also provides a more secure method where the WAP header will contain the MSISDN, and there will also be added security by using a combination of an account ID and transaction ID, together with the MSIDN for security authorisation.
2. The card holder can receive an SMS notification that contains a URL on his/her mobile phone. The card holder can click the URL and this could then work two ways;
a) clicking the URL could take you to another WAP page where the card holder has to confirm whether the card should be blocked or not, or
b) the system automatically loads a service that allows the card holder to block the PIN.
c) Another option that clicking the URL would take the card holder to an interne page where the card holder can block it on the phone. Again the blocking is secured using a combination of transaction ID, account ID and MSISDN for identification and authorisation. IPX can also be used as an added security layer.

A further aspect of the invention provides a system and method of calling a phone number and then to be routed to an IVR that will accept the code word and authentication orally without human interaction to automatically block a card holder's card for future usage and remove any exposure of card fraud. In order to improve security the system comprises means for using voice recognition to authenticate a transaction.

In one embodiment the system comprises means for replying with a generated token (for example RACOM) or a separate code generated and sent from a different system to the mobile number of the card holder, for example a one-time password when logging into RVI.

There is also provided a computer program comprising program instructions for causing a computer program to carry out the above method that may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 illustrates an overview of merchant alert system according to the present invention;

FIG. 2 illustrates merchant alert interfaces with fraud detection systems of any or all of parties involved in Card Payment handling;

FIG. 3 illustrates the different components making up the architecture of the merchant alert system, according to one aspect of the present invention;

FIG. 4 illustrates the Merchant Alert system architecture according to the invention;

FIG. 5 illustrates the call flow of the system when an Acquiring bank sends a disputed transaction as an e-mail and merchant receives alert notification via SMS message;

FIG. 6 illustrates the call flow of the system when an Acquiring bank sends disputed transaction as e-mail and merchant receives alert notification via e-mail message;

FIG. 7 illustrates the call flow of the system when an acquiring bank sends disputed transaction as an e-mail and alert is sent directly to the merchant's system;

FIG. 8 illustrates the call flow when Merchant Alert receives disputed transactions directly from the acquiring bank's Fraud Detection System and the merchant receives alert notification via SMS message;

FIG. 9 illustrates the call flow when Merchant Alert receives disputed transactions directly from the acquiring bank's Fraud Detection System and merchant receives alert notification via e-mail message;

FIG. 10 illustrates the call flow when Merchant Alert receives disputed transactions directly from the acquiring bank's Fraud Detection System and alert is sent directly to the merchant's system;

FIG. 11 illustrates the call flow when Merchant accesses a merchant alert website to view alerts; and

FIG. 12 illustrates merchant alert system according to one aspect of the invention.

### DETAILED DESCRIPTION OF THE DRAWINGS

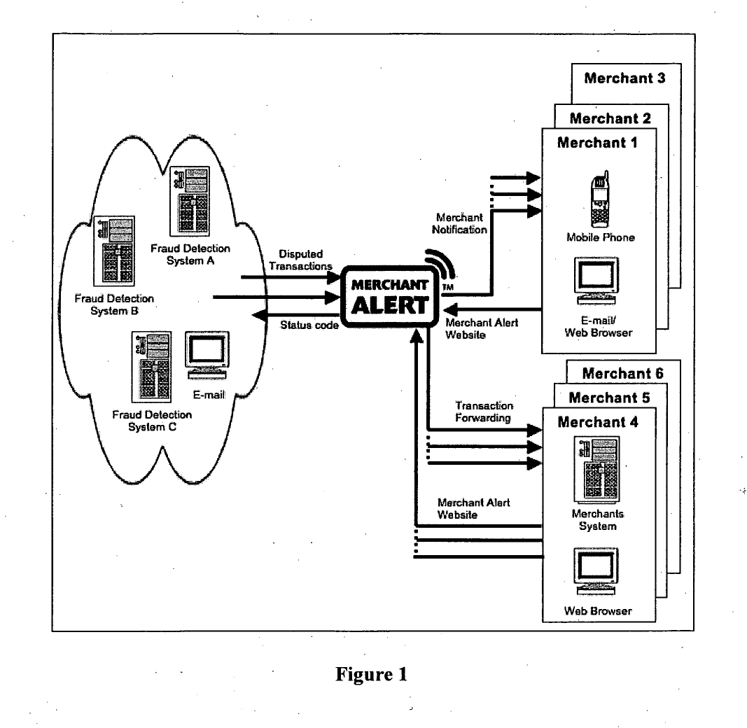

FIG. 1 illustrates a block diagram overview of the present invention, hereinafter referred to as Merchant Alert. The Merchant Alert communicates with one of more fraud detection systems and one or more merchants via electronic communication means. Merchant Alert can be a hosted subscription based notification and card control service, aimed at addressing the ever-increasing problem of card fraud. The system to implement the merchant alert is a high capacity, high availability, and high performance fraud notification and alert service for merchants who handle payment card transactions. In operation, when a Card Holder purchases goods or a service from a merchant several financial institutions may be involved in the payment process and authorisation, as illustrated in FIG. 1. A typical Card Holder purchase with a fraud prevention system for a customer is described in co-pending PCT application number PCT/IE2009/000088, assigned to Moqom Limited and incorporated herein by reference.

Merchant Alert will interface with the acquiring banks and makes it possible for the acquiring bank to send details of disputed transactions to Merchant Alert in an electronic spreadsheet (such as an electronic spreadsheet such as Excel) as e-mail attachments. Essentially the Merchant Alert acts as a conduit, receiving disputed transaction details and forwarding and/or displaying them to the merchant, the operation of which is discussed in more detail below.

The Merchant Alert system can interface with the fraud detection systems of any or all of the following parties in order to advise the merchant in a timely manner that a disputed transaction has taken place:
Merchant
Payment Service Provider (PSP)
Acquiring Bank
Card Association
Card Issuing Bank

Multiple Fraud Detection Systems can connect to Merchant Alert to provide a feed of disputed transactions to the merchant which otherwise would not receive a quick feedback regarding disputed transactions. The solution of the invention operates on the basis that disputed transactions pertaining to a particular merchant are fed to Merchant Alert from a Fraud Detection System through the Disputed Transaction Interface or in electronic spreadsheets (such as Excel) as E-mail attachments.

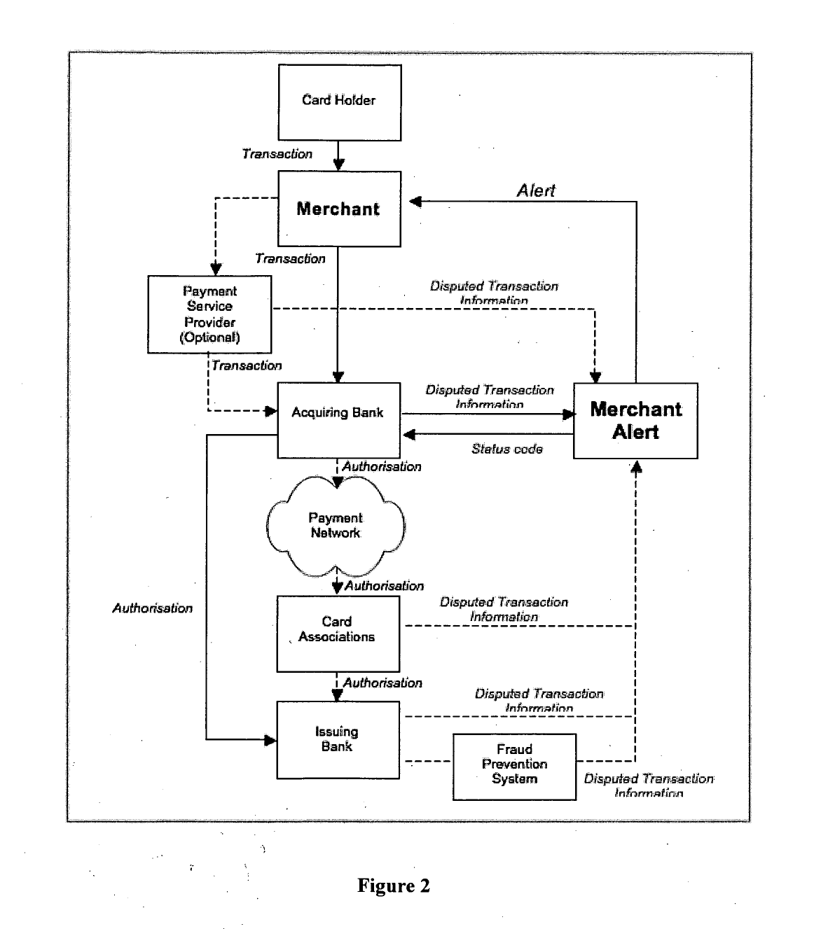

Referring now to FIG. 2, FIG. 2 defines the scope of Merchant Alert according to a preferred embodiment of the invention. Merchant Alert advises the particular merchant of that disputed transaction. A Cardholder purchasing goods or a service from a Merchant initiates a card transaction towards the Merchant. The transaction will be forwarded from the Merchant to the Acquiring Bank.

The Acquiring Bank will query Merchant Alert to see if this transaction is a disputed transaction or not. Merchant Alert will provide a status code back the Acquiring Bank. The status code will indicate whether or not the transaction is authorised by Merchant Alert or not. If the transaction is a disputed Merchant Alert will alert the Merchant. The merchant can receive information about a disputed transaction by:
1. An SMS notification containing a message informing the merchant that a disputed transaction has occurred and to login to the Merchant Alert Website to view the alert.
2. An E-mail notification containing a unique URL to the alert enabling the merchant to connect to the Merchant Alert Website using a web browser to view details of the disputed transaction.
3. An alert automatically sent to the merchant's internal system using the Transaction Forwarding interface. The merchant can view the details of the disputed transaction through their own system or alternatively connect to the Merchant Alert Website using a web browser to view the details.

If Merchant Alert authorises the transaction, i.e. it is not a disputed transaction, the Acquiring Bank sends the transaction for Authorisation to the Card Associations for authorisation over the payment network. A Card Association is any entity formed to administer and promote credit and cards, e.g. MasterCard and Visa.

If the Card Association does not authorise the card transaction for any reason, a notification will be sent to Merchant Alert informing that the transaction is a Disputed Transaction. Merchant Alert will in turn alert the Merchant using the notification method described above.

If the transaction is authorised by the Card Associations, the Card Associations will send the card transaction to the Issuing Bank for Authorisation. The Issuing Bank may identify this transaction as a disputed transaction and send a notification to Merchant Alert to notify the Merchant via the notification methods described above. The Issuing Bank can also send the transaction to FPS which will alert the card holder about the transaction taking place on the card in question. The card holder then has the opportunity to block the card for future fraud and flag the transaction as fraudulent. In this event FPS, will notify Merchant Alert that the transaction is fraudulent or disputed. Merchant Alert will in turn alert the Merchant using the notification method described above.

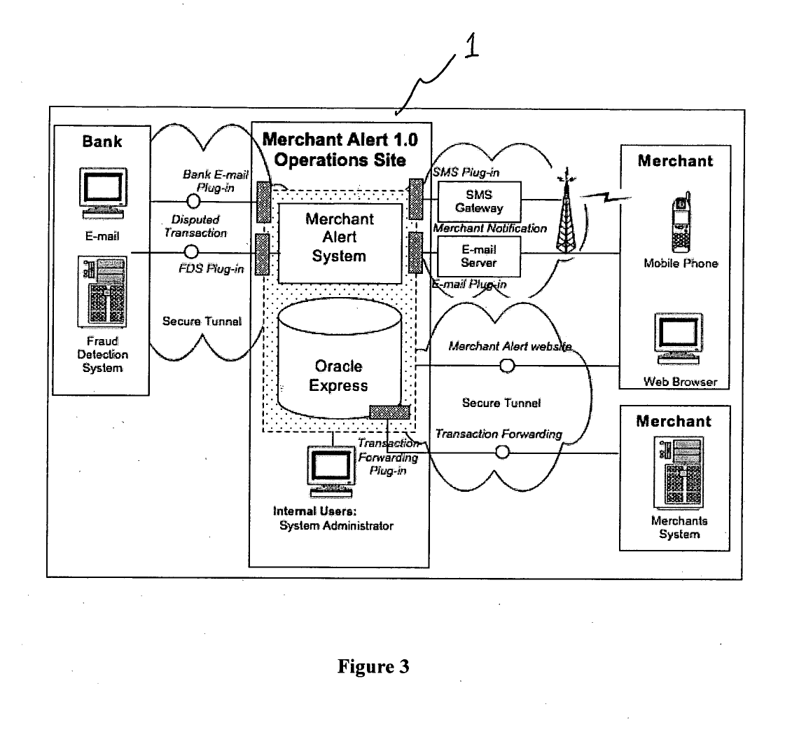

FIG. 3 shows the structure of Merchant Alert and the external systems and users that communicate in detail, indicated generally by the reference numeral 1. Merchant Alert comprises a modular design and can be logically made up of the following component elements:
Disputed Transaction Interface—2
Merchant Alert Core—3
Transaction Receiver
Merchant and Organization Settings Handling
Billing
Statistics
Merchant Alerting Methods
Transaction Forwarding Methods
Merchant Database (for example, implemented using Oracle Express Edition database)
Merchant Notification Interface
Transaction Forwarding Interface
Web Portal Services
Merchant Alert Website

Merchant Alert can be provided with a solid plug-in architecture allowing for a simple integration with systems supporting the service. All plug-ins are easily adaptable to customer's requirements.

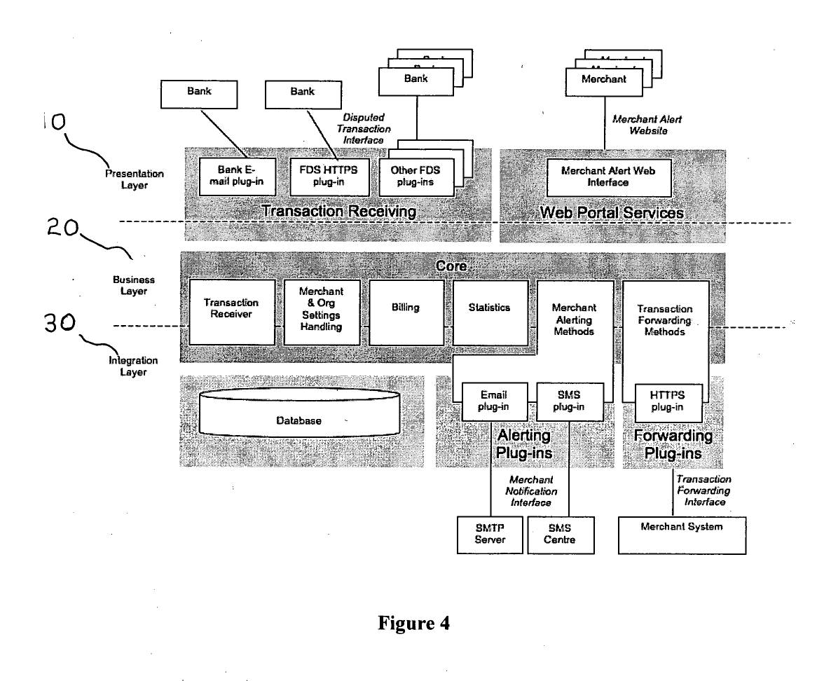

FIG. 4 gives a high-level overview of the different components of the Merchant Alert system architecture that can be divided into three system layers:

Presentation Layer—A presentation layer 10 contains part of Merchant Alert to which external systems and users send information. It also presents information for users to access and view. Since each external party may have its own specific connection methods, the presentation layer handles these different protocol types. Each external system connects by means of a plug-in which deals with the specific details of that type of connection. For example, some banks may wish to send e-mails containing a Microsoft Excel file with a number of disputed transactions. For these banks, the Banks E-mail plug-in is used.

Business Layer—A business layer 20 contains the main functionality of Merchant Alert. It is isolated from the specifics of the external systems, communication methods and implementations. For example, the business layer requires no changes if a new bank wished to send transactions to Merchant Alert using a new method, or if another database is added.

Integration Layer—An integration layer 30 contains the functionality for
Allowing the Merchant Alert to make data persistent by recording it in a database.
Allowing Merchant Alert to send data towards external systems. For example, the SMS Plug-in allows notification texts to be sent to merchants.
A disputed transaction interface is used to integrate Fraud Detection Systems directly with the Merchant Alert system. This interface carries information from Fraud Detection Systems within the payment network about transaction payments that are judged to be potentially fraudulent.

As Merchant Alert is a hosted solution interfacing with Fraud Detection Systems from various financial institutions (e.g. acquiring banks, issuing banks and payment service providers), there is one instance of this interface for each connected institution. Each instance is configured to meet the requirements and preferred communication protocol of the institution.

A Merchant Alert Core shown in FIG. 4 processes all disputed transactions received from a financial institution. Processing requires an optimisation of the Merchant Alert core system engines to essentially act as a filter. These modules are specifically designed to receive the transaction, quickly check the transaction and store the transaction details in the database. The modules also analyse the acquirer ID and merchant ID in order to retrieve the correct merchant profile. The modules shall then alerts the merchant according to their preferred method as per profile, namely; forward transaction to merchant's system; notify by SMS; or notify by E-mail. The Core is a grouping of system internal Merchant Alert components as follows:

### Transaction Receiver

The Transaction Receiver receives the disputed transactions from the acquiring bank either in an excel spreadsheet via the Bank E-mail plug-in or directly from the Fraud Detection System via the FDS HTTPS plug-in. The transaction receiver creates a new record in the database and initialises it with values taken from the incoming disputed transaction.

This component is also responsible for rendering the payment card number stored in the database if not already received as a rendered value. The component will render the card number to store only the last 4 digits. The core also initialises the database with an initial value (−1) to represent the notification state of the transaction. This notification state is updated once a notification has been sent to either 7 (success) or 8 (retry pending). The Merchant Alert thread is then initiated which checks the merchant to settings in the database and sends the alert or appropriate notification to the merchant according to the preferences.

The Transaction Receiver will respond to disputed transactions with one if the following status codes (Disputed Transaction Status Code) indicating the outcome of processing each transaction:

| Status | | |
|---|---|---|
| Code | Status Code Description | Description |
| 200 | trans_values_accepted | The disputed transaction has |
| | | been successfully processed by |
| | | Merchant Alert |
| −400 | mandatory_values_missing | The disputed transaction has not |
| | | been successfully processed as |
| | | some mandatory parameters |
| | | were missing |
| −499 | authenticationFailed | The username/password |
| | | combination was unsuccessfully |
| | | authenticated and the disputed |
| | | transaction has not been |
| | | processed. In this case, the first |
| | | disputed transaction will show |
| | | code −499, all other disputed |
| | | transactions in the excel |
| | | spreadsheet will show no status |
| | | code |
| −999 | system_error | A system error has occurred and |
| | | the acquiring bank should |
| | | contact the support organisation |

The presentation layer provides a Fraud Detection System (FDS) plug-in architecture shown in FIG. 4 allows the solution to support customised communication protocols across the disputed transaction interface. The protocols used are customised from the requirements of the interfacing institution. The FDS HTTPS plug-in is the HTTPS implementation of the Disputed Transaction Interface. However, the general operation of the FDS plug-in is standard regardless of the protocol used.

The FDS plug-in accepts disputed transactions in the form of a HTTPS Post data stream from the acquiring bank's Fraud Detection System. It carries out some checks on the transaction, to ensure that all mandatory parameters have been included.

Using the username and password parameters, the plug-in authenticates the sender of the transaction in the Web Portal Services component to ensure a valid acquiring bank has sent it. The transaction is passed to the transaction-filtering component where it is channelled to the correct merchant.

A HTTPS response is returned to the sending system with a result code. This result code indicates one of the following: success, failure due to mandatory parameters missing, or failure authentication.

The Presentation layer also provides a Bank E-mail Plug-in which allows for the system to come into operation without the need for direct integration between the financial institutions' Fraud Detection System and Merchant Alert. Banking Institutions, such as acquiring banks, can send an E-mail to Merchant Alert with the details of disputed transactions attached as a spreadsheet or simply in the body of an e-mail. The excel spreadsheets will contain the acquiring bank's username and password for verifying the e-mail in Merchant Alert and the same information elements about the disputed transaction.

Merchant Alert receives the E-mails from the acquiring bank and processes the disputed transaction information contained in the attached excel spreadsheets as alerts. The merchant is informed of a new alert through transaction forwarding or merchant notifications. The frequency at which Merchant Alert processes the excel spreadsheets is according to a predefined timeframe as agreed in the Service Level Agreement (SLA) with the merchant.

The plug-in checks a Merchant Alert email account (for example merchant.alert@moqom.com) for any incoming E-mails from the acquiring banks. The plug-in runs on a configurable schedule, for instance once every 20 minutes. The plug-in extracts all details for individual transactions populated in any excel files and the data is passed to the transaction-filtering component for processing. It also extracts the username and password populated in line 2 in order to authenticate the acquiring bank in the Web Portal Services component. The plug-in starts processing transactions beginning at line 4 of the file, and will continue processing the transactions until it finds 5 consecutive blank lines or until it reaches the end of the file. At this point it considers the file to be complete.

The excel files containing the transaction details are expected to be in the correct format. The acquiring banks are provided with a template with the correct format to populate the transaction details. If a transaction is not in the correct format then that individual transaction is ignored.

Once all excel files within an email have been processed, an acknowledgement E-mail is sent back to the sender with a similar excel file with status codes for each transaction confirming that transactions have been successfully processed, failed due to mandatory parameters missing, or failed authentication. The E-mail is subsequently deleted from the inbox. Merchant Alert will notify the acquiring bank via E-mail of certain status conditions:
If an E-mail is received by Merchant Alert with no excel spreadsheet attachment the system will respond with an E-mail informing the acquiring bank that the attachment is missing
If an E-mail is received by Merchant Alert with an excel spreadsheet attachment but with no rows populated, the system will respond with an E-mail informing the acquiring bank that the attachment is blank
If an E-mail is received by Merchant Alert with an excel spreadsheet attachment but with mandatory details missing, the system will respond with an E-mail informing the acquiring bank that the attachment is missing.
If an E-mail is received by Merchant Alert with an excel spreadsheet attachment with incorrect username/password combination, the system will respond with an E-mail informing the acquiring bank of authentication failure.
If an E-mail is received by Merchant Alert but there is a failure with the E-mail plug-in, the system will respond with an E-mail apologising to the acquiring bank for a system error and that support has been notified.

A disputed transaction function provides the capability for a Fraud Detection System to update the Merchant Alert system with a disputed transaction. The system is capable of receiving the following information elements about the disputed transaction: Note: O=Optional; M=Mandatory
Merchant ID (M)
Acquirer ID (M)
Card Number (O)
Account Number (O)
Transaction Date/Time (O)
Transaction Value (O)
Currency (O)
Blocking Date/Time (O)
Terminal ID (O)
Issuer ID (O)
Acquirer Transaction ID (O)
Status code (O)
Status description (O)
Custom 1 (O)
Custom2 (O)
Custom3 (O)
Custom4 (O)
Custom5 (O)
Custom6 (O)
Custom7 (O)
Custom8 (O)
Custom9 (O)
Custom 10 (O)

The purpose of the custom fields is to allow individual Acquiring Banks pass additional information within each transaction to their merchants.

Referring now again FIG. 4 the core provides a Merchant and Organization Settings Handling module. Each merchant is provisioned in the database with a record containing verification information, notification plug-in preference, and notification address. The verification information allows a cross check between the merchant ID and acquirer ID provisioned in the record with merchant ID and acquirer ID provided in a transaction received from the acquiring bank. The notification preference indicates how the merchant prefers to be notified, and may be set to the following values:
No notification.
SMS—Notification takes place via SMS gateway and the notification address is the IMSI of the merchant.
EMAIL—Notification takes place via E-mail server and the notification address is the E-mail address of the merchant
HTTP_POST—No notification takes place, instead the transaction alert is forwarded directly to the merchant's system.

A billing component is provided in the core where records are stored of billable events that take place within Merchant Alert. The following billable events generate Data Records (DRs) that are received and recorded by the Billing component:
Transactions received from acquiring banks via disputed transaction Interface
Transactions received from acquiring banks via Email Interface
Merchant No Alert required
Transactions forwarded to Merchants
Merchant Notifications sent by E-mail
Merchant Notifications sent by SMS
Merchant Notifications via SMS successfully delivered
Merchant Notifications via SMS failed delivery

A statistics component records a count on the following:
Transactions received from acquiring banks via disputed transaction Interface
Transactions received from acquiring banks via Email Interface
Merchant No Alert required
Transactions forwarded to Merchants
Merchant Notifications sent by E-mail
Merchant Notifications sent by SMS
Merchant Notifications via SMS successfully delivered
Merchant Notifications via SMS failed delivery

At the end of each day the statistics can be archived.

An important aspect of the core is the Merchant Alerting component. The Merchant Alerting component includes the logic behind individual alerting methods. The Merchant and Organisation Settings Handling component informs the Merchant Alerting method of the merchant's preferred notification method and the corresponding address details; MSISDN for SMS notification or E-mail address for E-mail notification.

For SMS notifications it dispatches a standard SMS message informing the merchant that a disputed transaction has occurred and to login to the Merchant Alert Website to view the alert. It then dispatches the SMS notification to the merchant's MSISDN.

For E-mail notifications it processes the transactions passed to it from the transaction filtering and reporting component and compiles E-mail notification message with the unique URL required for the merchant to access the alert in the Merchant Alert Website. It then dispatches the E-mail notification to the merchants E-mail address.

A Transaction Forwarding comprises the logic behind the forwarding of transactions to merchant's system. The Merchant and Organisation Settings Handling component informs the Transaction Forwarding method that the merchant is set up for receiving transaction alerts and obtains the IP address for the merchant's system. The Transaction Forwarding method forwards the transaction alerts directly to the merchant's system.

All merchants information should be provisioned in a Merchant Database with details for notification and transaction alert preferences, E-mail addresses, MSISDNs, system IP addresses, usernames and passwords. Merchant Alert components query the database when individual merchant information is required by the service.

Acquiring Bank details are also stored in the database. Acquiring Banks must be provisioned with preferred method for alerting Merchant Alert of disputed transactions, the IP addresses of the Fraud Detection System, E-mail addresses for receiving excel spreadsheets, usernames and passwords. Furthermore, the database stores the details of the disputed transactions as received from the acquiring banks.

Referring again to FIG. 3 in detail, FIG. 3 shows the structure of Merchant Alert and the external systems and users that communicate with the system. The system comprises a main database, for example an Oracle express edition database. The Oracle express edition database should contain the following information about the merchants:
Merchant Name
Merchant ID
Plug-in type
Notification Address/Transaction Forwarding Address
Username
Password

The following are information about the acquiring bank is also in the Merchant Alert database:
Organisation ID
Username
Password

The following are information elements contained in an alert about a disputed transaction and are also stored in the Merchant Alert database:
Merchant ID
Acquirer ID
Card Number (last 4 digits)
Account Number
Transaction Date/Time
Transaction Value
Currency
Blocking Date/Time
Terminal ID
Issuer ID
Acquirer Transaction ID
Status code
Status description
Custom1
Custom2
Custom3
Custom4
Custom5
Custom6
Custom7
Custom8
Custom9
Custom10

The purpose of the custom fields is to allow individual Acquiring Banks pass additional information within each transaction to their merchants.

A merchant notification interface offers flexible alerting rules and the method by which disputed transactions are made known to the merchant is configurable in the system. The merchant can receive a notification that an alert exists and the merchant can connect using a web browser to the Merchant Alert Website and view the details of the alert. Two types of notifications are possible; E-mail or SMS notification. The merchant notification interface is used to integrate Merchant Alert with the SMS server and E-mail server via the plug-ins.

The solution facilitates the notification of the merchant by SMS that a disputed transaction originating from that merchant has been detected and an alert created. SMS notifications contain a message informing the merchant that a disputed transaction has occurred and to login to the Merchant Alert Website to view the alert.

### SMS Gateway Plug-In

The SMS gateway connection plug-in is based on a HTTP interface enabling the Merchant Alert system to send SMS alert notifications to the SMS gateway and the merchant via, for example, Sremium's SMS service.

### Merchant Notification by E-Mail

The solution facilitates the notification of the merchant by E-mail that a disputed transaction originating from that merchant has been detected and an alert created. E-mail notifications contain a unique URL to the alert enabling the merchant to connect to the Merchant Alert Website using a web browser to view details of the disputed transaction. The unique URL is based on the transaction ID.

### E-mail Server Plug-In

The E-mail server connection plug-in is based on the SMTP interface enabling the Merchant Alert system to send e-mail alert notifications to the merchant via the e-mail server.

### Notification States

A notification is created in state ‘Unsent’. Once an attempt is made to send the notification, the state is updated. If successful, the state is updated to ‘Sent’. If unsuccessful, the state is updated to ‘Failed’.

In the event of a failed merchant notification attempt, the solution shall retry sending the notification. The number of notification retires is set by a configurable retry limit. When the limit is reached, the system shall raise a notification that shall be handled user support.

### Transaction Forwarding Interface

The Transaction Forwarding interface allows Merchant Alert to connect and pass information of disputed transactions directly to Merchant's in-house system.

The solution facilitates the notification of the merchant by informing an in-house system that a disputed transaction originating from that merchant has been detected. The merchant's system belongs to and is hosted by the merchant. The merchant can view the details of the disputed transaction through their own system or alternatively connect to the Merchant Alert Website using a web browser to view the details.

### Transaction Forwarding HTTPS Plug-In

The Transaction Forwarding interface is based on a secure interface to the merchant's system for communicating disputed transactions. With the Merchant Alert plug-in architecture, it is very easy to adapt the Transaction Forwarding plug-in to connect directly to the merchants own system.

The Transaction Forwarding plug-in is based on the HTTPS protocol. However, it will be possible to develop specific plug-ins for integration with the merchant's system to support customised communication protocols based on agreements.

### Web Portal Services

The Merchant Alert Website consists of a set of pages where a merchant can view details of disputed transactions. To use the service, a merchant must be provisioned with user credentials for the website. The Web Portal Services component provides login and session management facilities. It authenticates the merchant's username and password against the database. The Web Portal Services component also authenticates the acquiring banks username and password against the database.

The merchant can access the following pages when not logged in to the Merchant Alert Website:
Home—Provides general information about the Merchant Alert service and a login prompt.
Support—Provides contact information for the service.

Once a merchant has logged in to the Merchant Alert Website, two more pages become available:
Alerts—This page operates in two modes.
Recent Alerts Mode—The page displays a list of alerts for a particular merchant. The list contains the following headings: Terminal ID, Transaction Occurred Time, Transaction Disputed Time, Transaction Amount, and Card. The list is sorted by transaction time, with the most recent on top. The list is divided into pages with 15 alerts per page. Every alert may be clicked on to switch to the Alert Details mode.
Alert Details Mode—In this mode, the page displays detailed information about disputed transactions
   Your Account—This page provides a facility for a merchant to change the password.

### Merchant Alert Website

The Merchant Alert Website is based on a secure web interface whereby merchants can log directly into the Merchant Alert Website using a web browser to view status of alerts and to receive details about disputed transactions.

All disputed transaction alerts sent to Merchant Alert are stored within the Oracle database and are made viewable to the merchant through the Merchant Alert Website.

Details of disputed transactions presented to merchants are configurable on a per merchant basis.

### Alert Information

The following information elements of the disputed transaction alerts may be displayed to the merchant in the Merchant Alert Website:
Merchant ID
Acquirer ID
Card Number (last 4 digits)
Account Number
Transaction Date/Time
Transaction Value
Currency
Blocking Date/Time
Terminal ID
Issuer ID
Acquirer Transaction ID
Status code
Status description
Custom1
Custom2
Custom3
Custom4
Custom5
Custom6
Custom7
Custom8
Custom9
Custom10

The purpose of the custom fields is to allow individual Acquiring Banks pass additional information within each transaction to the respective merchants.

### Merchant Alert User Access

### User Access Privileges

Each Merchant Alert client organization employee, who is a user of the system, is configured in the system, to have merchant access, with a username and password. The merchant access has the capability to work with alerts for its own organization. The solution restricts data access of employees of Merchant Alert client organisation to only access the organization area for which they are registered.

### System Administrator

The system provides one overall system administrator role through which the system as a whole is administrated.

### Merchant Alert Flow

Once Merchant Alert has received a disputed transaction has been received from the acquiring bank, the service stores the information elements of the disputed transaction alerts.

Merchant Alert can receive the details of disputed transaction from the acquiring bank in one of two methods; directly from the banks Fraud Detection System (FDS) or from excel spreadsheets attached in an E-mail.

When a disputed transaction is stored in the database, Merchant Alert checks for the merchant's profile and the alert notification settings registered for the particular merchant in the database. The notification preference indicates how the merchant prefers to be notified, and may be set to the following values for Merchant Alert:
No notification.
SMS—Notification takes place via SMS gateway and the notification address is the IMSI of the merchant.
EMAIL—Notification takes place via E-mail server and the notification address is the E-mail address of the merchant
HTTP_POST—No notification takes place, instead the transaction alert is forwarded directly to the merchant's system.

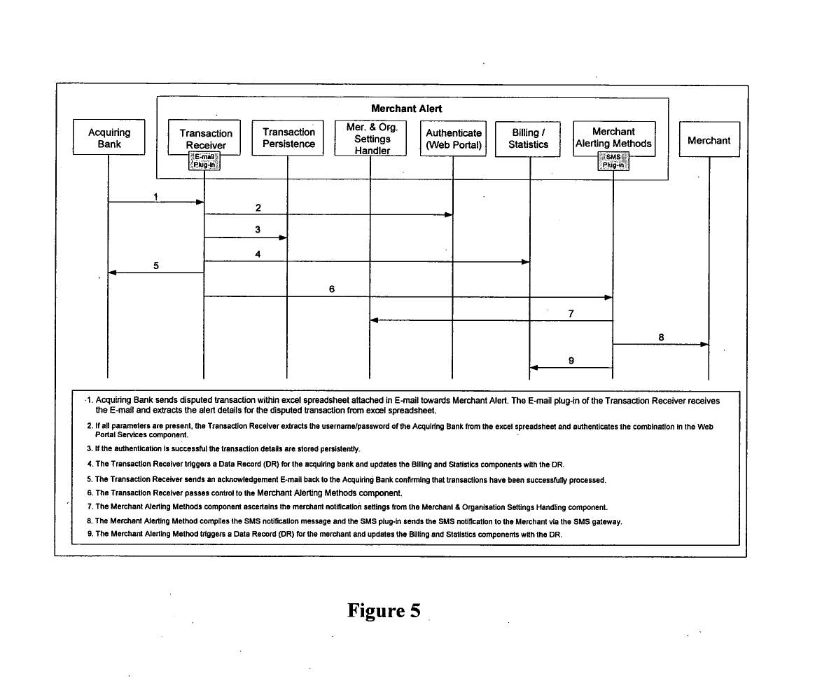

The following describes the call flows, with reference to FIGS. 5 to 11, for each combination of acquiring bank alerting Merchant Alert of disputed transactions and Merchant Alert notifying the merchant of alerts:

FIG. 5 describes the call flow when the acquiring bank sends disputed transaction as E-mail and merchant receives alert notification via SMS message.

1. Acquiring Bank sends disputed transaction within excel spreadsheet attached in E-mail towards Merchant Alert. The E-mail plug-in of the Transaction Receiver receives the E-mail and extracts the alert details for the disputed transaction from excel spreadsheet.
2. If all parameters are present, the Transaction Receiver extracts the username/password of the Acquiring Bank from the excel spreadsheet and authenticates the combination in the Web Portal Services component.
3. If the authentication is successful the transaction details are stored persistently.
4. The Transaction Receiver triggers a Data Record (DR) for the acquiring bank and updates the Billing and Statistics components with the DR.
5. The Transaction Receiver sends an acknowledgement E-mail back to the Acquiring Bank confirming that transactions have been successfully processed.
6. The Transaction Receiver passes control to the Merchant Alerting Methods component.
7. The Merchant Alerting Methods component ascertains the merchant notification settings from the Merchant & Organisation Settings Handling component.
8. The Merchant Alerting Method compiles the SMS notification message and the SMS plug-in sends the SMS notification to the Merchant via the SMS gateway.
9. The Merchant Alerting Method triggers a Data Record (DR) for the merchant and updates the Billing and Statistics components with the DR.

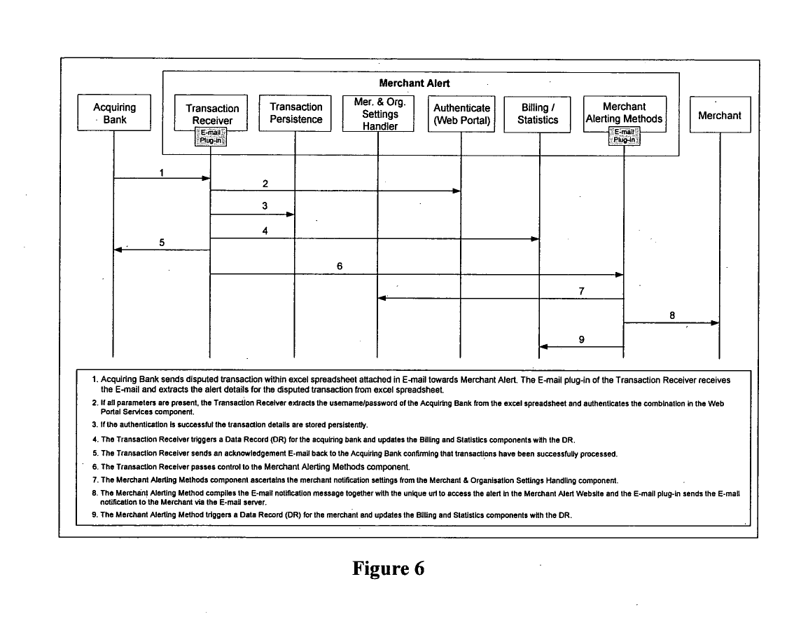

FIG. 6 describes the call flow when the acquiring bank sends disputed transaction as E-mail and merchant receives alert notification via an E-mail message:

1. Acquiring Bank sends disputed transaction within excel spreadsheet attached in E-mail towards Merchant Alert. The E-mail plug-in of the Transaction Receiver receives the E-mail and extracts the alert details for the disputed transaction from excel spreadsheet.
2. If all parameters are present, the Transaction Receiver extracts the username/password of the Acquiring Bank from the excel spreadsheet and authenticates the combination in the Web Portal Services component.
3. If the authentication is successful the transaction details are stored persistently.
4. The Transaction Receiver triggers a Data Record (DR) for the acquiring bank and updates the Billing and Statistics components with the DR.
5. The Transaction Receiver sends an acknowledgement E-mail back to the Acquiring Bank confirming that transactions have been successfully processed.
6. The Transaction Receiver passes control to the Merchant Alerting Methods component.
7. The Merchant Alerting Methods component ascertains the merchant notification settings from the Merchant & Organisation Settings Handling component.
8. The Merchant Alerting Method compiles the E-mail notification message together with the unique url to access the alert in the Merchant Alert Website and the E-mail plug-in sends the E-mail notification to the Merchant via the E-mail server.
9. The Merchant Alerting Method triggers a Data Record (DR) for the merchant and updates the Billing and Statistics components with the DR.

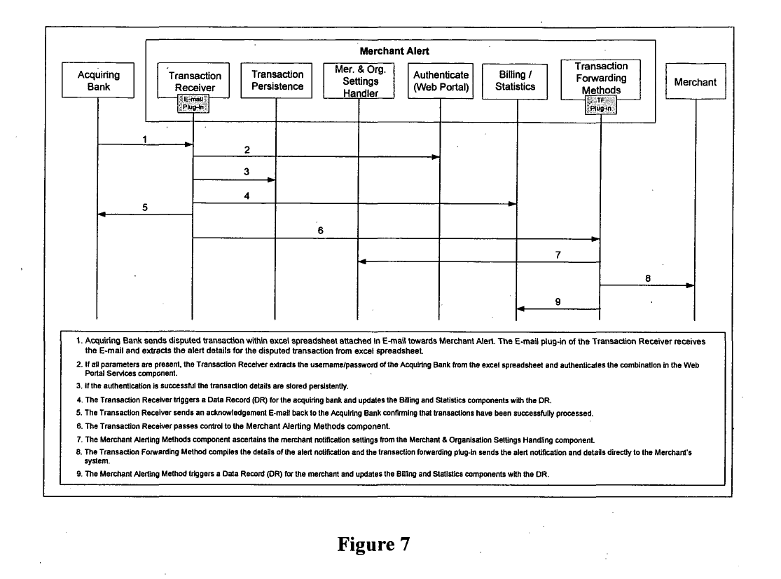

FIG. 7 describes when the acquiring bank sends disputed transaction as E-mail and alert is sent directly to the merchant's system:

1. Acquiring Bank sends disputed transaction within excel spreadsheet attached in E-mail towards Merchant Alert. The E-mail plug-in of the Transaction Receiver receives the E-mail and extracts the alert details for the disputed transaction from excel spreadsheet.
2. If all parameters are present, the Transaction Receiver extracts the username/password of the Acquiring Bank from the excel spreadsheet and authenticates the combination in the Web Portal Services component.
3. If the authentication is successful the transaction details are stored persistently.
4. The Transaction Receiver triggers a Data Record (DR) for the acquiring bank and updates the Billing and Statistics components with the DR.
5. The Transaction Receiver sends an acknowledgement E-mail back to the Acquiring Bank confirming that transactions have been successfully processed.
6. The Transaction Receiver passes control to the Merchant Alerting Methods component.
7. The Merchant Alerting Methods component ascertains the merchant notification settings from the Merchant & Organisation Settings Handling component.
8. The Transaction Forwarding Method compiles the details of the alert notification and the transaction forwarding plug-in sends the alert notification and details directly to the Merchant's system.
9. The Merchant Alerting Method triggers a Data Record (DR) for the merchant and updates the Billing and Statistics components with the DR.

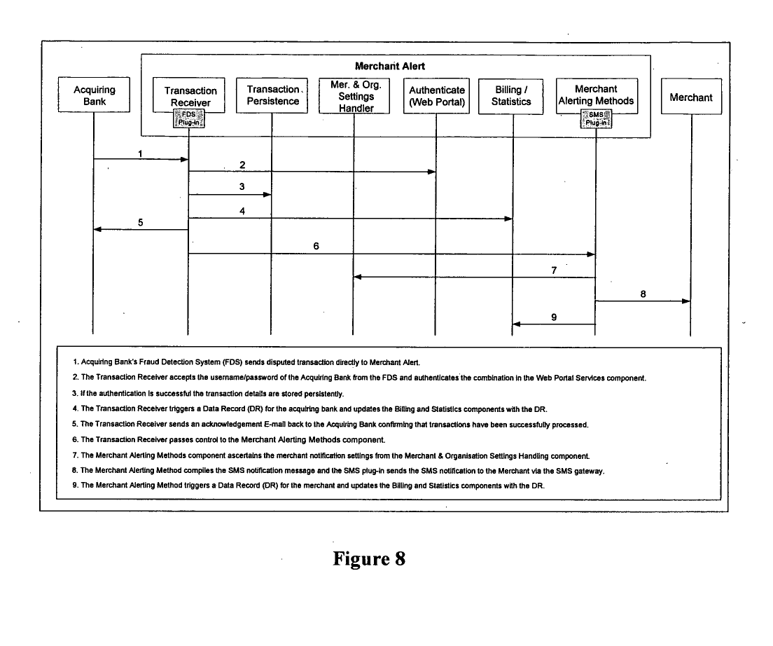

FIG. 8 describes when Merchant Alert receives disputed transactions directly from the acquiring bank's Fraud Detection System and the merchant receives alert notification via SMS message.

1. Acquiring Bank's Fraud Detection System (FDS) sends disputed transaction directly to Merchant Alert.
2. The Transaction Receiver accepts the username/password of the Acquiring Bank from the FDS and authenticates the combination in the Web Portal Services component.
3. If the authentication is successful the transaction details are stored persistently.
4. The Transaction Receiver triggers a Data Record (DR) for the acquiring bank and updates the Billing and Statistics components with the DR.
5. The Transaction Receiver sends an acknowledgement E-mail back to the Acquiring Bank confirming that transactions have been successfully processed.
6. The Transaction Receiver passes control to the Merchant Alerting Methods component.
7. The Merchant Alerting Methods component ascertains the merchant notification settings from the Merchant & Organisation Settings Handling component.
8. The Merchant Alerting Method compiles the SMS notification message and the SMS plug-in sends the SMS notification to the Merchant via the SMS gateway.
9. The Merchant Alerting Method triggers a Data Record (DR) for the merchant and updates the Billing and Statistics components with the DR.

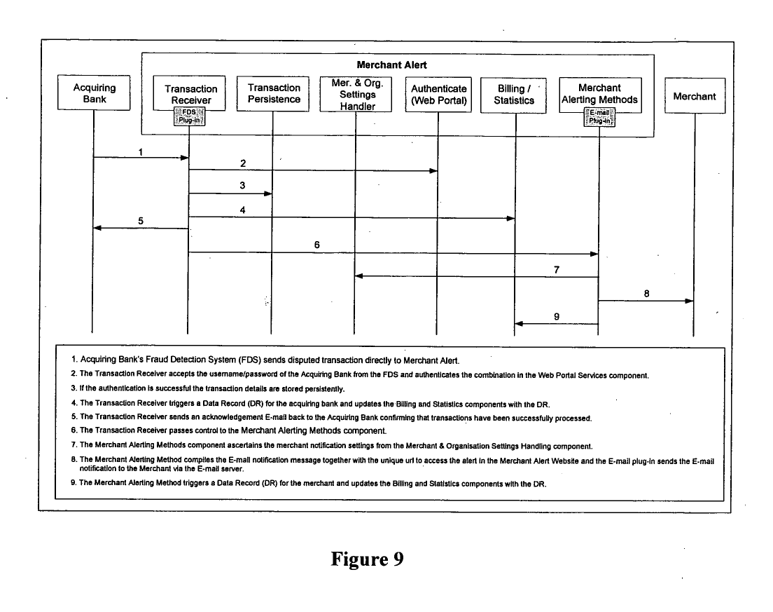

FIG. 9 describes when Merchant Alert receives disputed transactions directly from the acquiring bank's Fraud Detection System and merchant receives alert notification via E-mail message:

1. Acquiring Bank's Fraud Detection System (FDS) sends disputed transaction directly to Merchant Alert.
2. The Transaction Receiver accepts the username/password of the Acquiring Bank from the FDS and authenticates the combination in the Web Portal Services component.
3. If the authentication is successful the transaction details are stored persistently.
4. The Transaction Receiver triggers a Data Record (DR) for the acquiring bank and updates the Billing and Statistics components with the DR.
5. The Transaction Receiver sends an acknowledgement E-mail back to the Acquiring Bank confirming that transactions have been successfully processed.
6. The Transaction Receiver passes control to the Merchant Alerting Methods component.
7. The Merchant Alerting Methods component ascertains the merchant notification settings from the Merchant & Organisation Settings Handling component.
8. The Merchant Alerting Method compiles the E-mail notification message together with the unique url to access the alert in the Merchant Alert Website and the E-mail plug-in sends the E-mail notification to the Merchant via the E-mail server.
9. The Merchant Alerting Method triggers a Data Record (DR) for the merchant and updates the Billing and Statistics components with the DR.

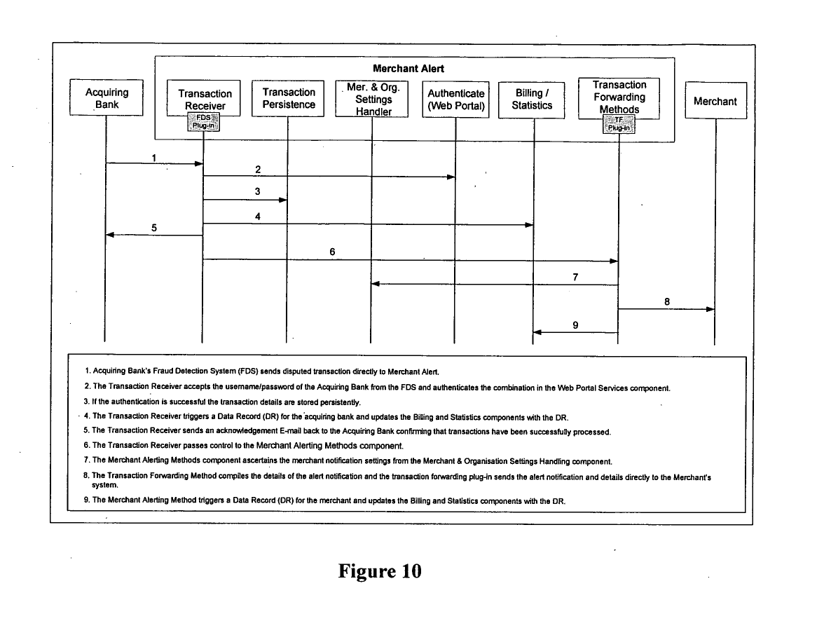

FIG. 10 describes Merchant Alert receives disputed transactions directly from the acquiring bank's Fraud Detection System and alert is sent directly to the merchant's system:

1. Acquiring Bank's Fraud Detection System (FDS) sends disputed transaction directly to Merchant Alert.
2. The Transaction Receiver accepts the username/password of the Acquiring Bank from the FDS and authenticates the combination in the Web Portal Services component.
3. If the authentication is successful the transaction details are stored persistently.
4. The Transaction Receiver triggers a Data Record (DR) for the acquiring bank and updates the Billing and Statistics components with the DR.
5. The Transaction Receiver sends an acknowledgement E-mail back to the Acquiring Bank confirming that transactions have been successfully processed.
6. The Transaction Receiver passes control to the Merchant Alerting Methods component.
7. The Merchant Alerting Methods component ascertains the merchant notification settings from the Merchant & Organisation Settings Handling component.
8. The Transaction Forwarding Method compiles the details of the alert notification and the transaction forwarding plug-in sends the alert notification and details directly to the Merchant's system.
9. The Merchant Alerting Method triggers a Data Record (DR) for the merchant and updates the Billing and Statistics components with the DR.

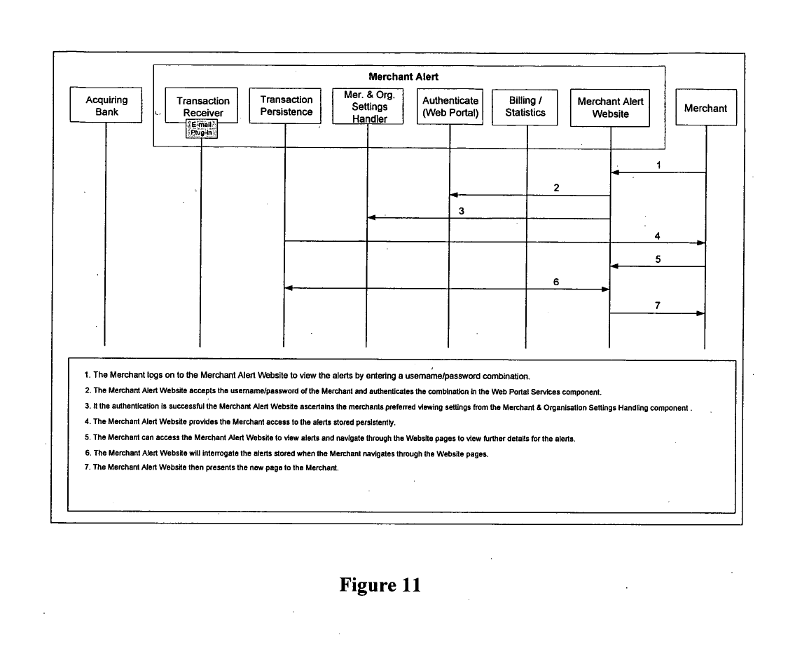

FIG. 11 describes when a merchant accesses the Merchant Alert Website to view alerts:

1. The Merchant logs on to the Merchant Alert Website to view the alerts by entering a username/password combination.
2. The Merchant Alert Website accepts the username/password of the Merchant and authenticates the combination in the Web Portal Services component.
3. It the authentication is successful the Merchant Alert Website ascertains the merchants preferred viewing settings from the Merchant & Organisation Settings Handling component.
4. The Merchant Alert Website provides the Merchant access to the alerts stored persistently.
5. The Merchant can access the Merchant Alert Website to view alerts and navigate through the Website pages to view further details for the alerts.
6. The Merchant Alert Website will interrogate the alerts stored when the Merchant navigates through the Website pages.
7. The Merchant Alert Website then presents the new page to the Merchant.

It will be appreciated security is one of the main focus areas in the Merchant Alert solution. Merchants and acquiring banks can be assured that no unauthorized access to data is possible, and that even authorized access to data is automatically tracked per user. Security can be addressed on the following levels:
Location Security
   All systems located at secure premises
   Only authorized personnel have access to servers
Access security
   Connection between each Fraud Detection System and the Merchant Alert solution shall be through an IPSec Virtual Private Network (VPN) only.
   Transactions received by Merchant Alert from acquiring banks shall be authenticated by username/password.
   Merchants accessing the Merchant Alert Website can only view transactions for their own organisation.
   Merchants shall be authenticated by username/password when accessing the Merchant Alert Website.
   The solution restricts data access of employees of Merchant Alert client organizations to only access the organization area for which they are registered.
   Every individual accessing Merchant Alert must do so by providing a unique personal identifier. No group log-ins is allowed.
Security Audits and Assessments
   Actively evaluating our security measures by conducting penetration testing on a regular basis.
   Executing security audits on a yearly basis.
   Penetration testing and security audits will be performed.
   The IP Infrastructure has IDS systems and security threat Management Solution that will be monitored 24/7 by the Network Operation Centre.
System security
   The system of the present invention carries out regular tests of the security processes and ensures that the security policies are maintained.
   Legal requirements
   All personal data is stored and handled in conjunction with the Data Protection Act.
Application Security
   No personal or client data is recorded in transaction or error logs.
   At no point is any card number recorded in a log file or transaction logs.
   The transaction notification, e.g. SMS, expires after a configurable time.
   No merchant details or personal data is sent in the notification.
Notification security
   No personal data or potential fraud details are sent in the notification.

Careful precautions have been made to protect the Merchant Alert servers from intruders by hiding the server behind firewalls and proxies.

The present invention also offers a statistical reporting tool that provides statistics on the system performance, i.e. number of amber transaction received, number of outgoing notifications sent and number of alerts sent. Statistical information and Data Records (DRs) shall be created for each event of significance and stored in a database table. The following trigger points cause Data Records to be generated in the service:
Transactions received from acquiring banks via disputed transaction Interface
Transactions received from acquiring banks via Email Interface
Merchant No Alert required
Transactions forwarded to Merchants
Merchant Notifications sent by E-mail
Merchant Notifications sent by SMS
Merchant Notifications via SMS successfully delivered
Merchant Notifications via SMS failed delivery

Statistics will be gathered on a per merchant basis and recorded in log files. The individual counters are incremented each time the specific event occurs. A new statistics log file can be created every 24 hours for each merchant. The statistics will be extracted from the database and stored in a new file per merchant. An additional global statistics log file contains aggregate of each counter for easier presentation. The system will remove log files older than a configurable period.

### Billing/Data Record Generation:

The charging of the Merchant Alert service is flexible and is based on post-processing of Data Records. There are multiple triggers that will generate a Data Record and add a new entry in the Data Record database each time a trigger is hit. These Data Records may be used for output to billing systems and for statistics.

Data Records (DRs) shall be created for each event of significance and stored in a database table. The following trigger points cause Data Records to be generated in the service:
Transactions received from acquiring banks via disputed transaction Interface
Transactions received from acquiring banks via Email Interface
Merchant No Alert required
Transactions forwarded to Merchants
Merchant Notifications sent by E-mail
Merchant Notifications sent by SMS
Merchant Notifications via SMS successfully delivered
Merchant Notifications via SMS failed delivery

The following details are contained in the Data Record:

| Item | Parameter | Description |
|---|---|---|
| 1 | merch_org_id | An id identifying the merchant organisation |
| | | provisioned in the Merchant Alert service. |
| 2 | acq_org_id | An id identifying the Acquiring Bank |
| | | organisation owning the Merchant. |
| 3 | app_trans_id | A transaction id allocated by the Merchant |
| | | Alert service when an incoming transaction is |
| | | received from the Fraud Detection System. |
| 4 | bank_trans_id | An id uniquely identifying the transaction |
| | | in the banks system. |
| 5 | terminal_id | An id that uniquely identifies the terminal used |
| | | to process the transaction. E.g. ATM, card |
| | | swiping machine etc. |
| 6 | merchant_id | An id in the banks system identifying the |
| | | merchant. |
| 7 | Acquirer_id | An id sent in the transaction from the acquiring |
| | | bank identifying the acquiring bank |
| | | organization. |
| 8 | trans_amount | An integer value of the transaction amount. |
| 9 | alert_plugin | Plug-in interface through with the alert is |
| | | delivered. E.g. SMS, EMAIL or Transaction |
| | | Forwarding. |
| 10 | alert_address | Address to which the alert notification is sent. |
| | | E.g. E-mail address, SMS number, IP address |
| 11 | event_dateTime | Date and time of event |
| 12 | event | An integer value relating to the disputed |
| | | transaction alert type sent to merchant. E.g. |
| | | 110 = Alert Notification sent as SMS |
| | | 130 = Alert Notification sent as E-mail |
| | | 140 = Alert sent to Merchants Automated |
| | | system |
| 13 | event_desc | A textual description of the event information. |
| | | E.g. “Disputed Transaction notification SMS |
| | | sent” “Disputed Transaction notification |
| | | EMAIL sent” “Transaction notification HTTP |
| | | sent” |
| 14 | billing_amount | Currently not populated. This parameter is |
| | | reserved for future use with a billing system. |

It will be appreciated that the Merchant Alert Solution of the present invention provides a number of advantages:
1. When fraud is not detected at transaction time, it may be disputed by the genuine cardholder up to 60 days after it takes place, resulting in a possible chargeback to the merchant at that point, usually long after goods have exchanged hands or services have been rendered. Identification of fraud within the delivery window saves the merchant from fraud-related financial loss. Merchant Alert provides information that significantly reduces the risk of chargeback to the merchant.
2. Detection of a fraud could take for some Fraud Detection Systems as little as 5 minutes from the time of purchase.
3. The merchant is allowed to identify disputed high-risk transactions. This information may assist the merchant in deciding whether to proceed or not with a particular disputed transaction.
4. Merchant Alert is a registration based service.
5. Only merchants registered to the service will be alerted and access information regarding disputed transactions for the particular merchant.
6. Each merchant can be configured to have the alerting method set to the merchants own requirements, whether it be via SMS or E-mail notification or have the alerts forwarded directly to the merchant's system.
7. Merchant Alert supports the financial institutions to alert the merchants in a timely and coherent manner.
8. Highly secure solution.

Having a centralised fraud detection service is very beneficial for all banks in Ireland, and outside of Ireland, since today there is no awareness of card fraud occurs in other banks. Such a centralised third party fraud detection service allows all banks to collaborate in a joint effort to prevent fraud while still maintaining complete confidentiality of the fraud level occurring in a particular bank. For example, thieves will use cards belonging to a number of institutions when defrauding using a particular terminal or terminals in an area. Each bank may become aware of attacks against its own customers when calls are made to customer care, but it's only when attacks against customers of all banks are visible will the fraudsters activity become immediately visible. Gardaí can now be alerted and directed in near real time to the scene of a gangs activities. For the end customer it is an easy and secure way to control the use of the card at a minimum cost, since no major card charge will pass unnoticed.

Merchant Alert provides means for sending the blocking event received by the system from the card holder to the particular merchant where the transaction took place. A copy is sent to acquirers and when applicable to the payment service providers. Alerts are handled per merchant, only alerts referring to the particular merchant are sent, effectively in real time within a few minutes. This allows the merchant to choose between investigating the transaction further and if needed cancel the order immediately before the goods ever leaves the store/warehouse that are the subject of the transaction. This is especially advantageous to counter Card Not Present (CNP) fraud, e.g. purchases over internet.

The additional card fraud prevention service will increase the visibility and usage of card services. Integration with the customer system completes the fraud protection for all kind of fraud scenarios and enables a business to especially fight CNP fraud.

The merchant alert offers a branding service where an alert is sent to the merchant using the acquirer and payment service providers branding name, for example the notification alert is sent directly to the merchant but viewed as sent via the acquirer and payment service provider. The flexible branding capabilities ensure that acquirers and payment service providers get a tailor-made notification interface in line with the corporate visual identity enhancing the market brand positioning. For a financial group the user interface can easily be adapted to the needs of the local countries. The merchant alert can support different notification methods: HTTP POST, SMS or email. Merchant business processes can be adapted to allow for this new service. E.g. downloadable games might have a trial license for a few days until the full license is supplied (if no blocking events received).

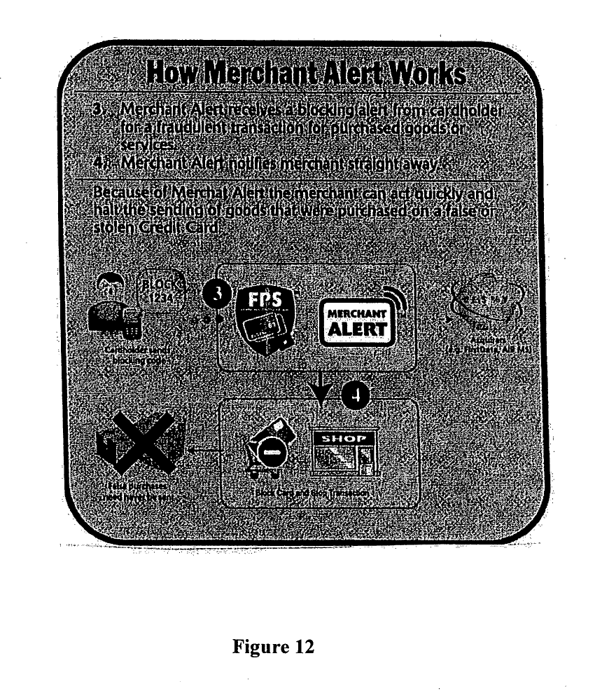

Referring to FIG. 12 illustrates the general operation of Merchant Alert according to the invention according to a preferred embodiment. Merchant Alert receives a blocking alert from cardholder for a fraudulent transaction for purchased goods or services. Merchant Alert notifies merchant straight away. Because of Merchant Alert the merchant can act quickly and halt the sending of goods that were purchased on a false or stolen Credit Card.

One of the main goals with Merchant Alert is to help a merchant to identify fraudulent attempts and help cut costs related to card fraud. FPS Merchant Alert offers a unique channel to the merchant, who otherwise will receive information of probable fraud after goods being shipped. By utilizing the merchant alert allows for having a direct and cost efficient channel to alert merchant of fraudulent activities. Prompt merchant notification gives the merchant an opportunity to stop goods being shipped for a disputed transaction. This enables merchants and banks to significantly minimize any losses for fraudulent transactions. The Merchant Alert system is fast and easy to deploy since it is a hosted solution. A hosted solution is making sure that a merchant will be quickly on track with a fraud prevention that supports the merchant needs. The Issuing bank sends the transaction events with additional details such as merchant_id, acquirer_id in addition to terminal_id. In order for the Merchant Alert (MA) identify the card holder personal details, the card holder can be identified form the Primary Access Number (PAN) of the card. In one embodiment the card holder details can be determined as follows:

1. MA receives the PAN from the Merchant
2. Issuing Bank is identified from the PAN
3. Request is sent from MA to the issuing Bank in order retrieve the account holder's phone number
4. The card holders number is retrieved to MA and the invention sends a notification to the card holder using the issuing bank's default profile in the invention to determine if to send SMS, WAP or make IVR call, for example using a system hereinbefore described or with reference to a FPS system described in PCT/IE2009/IE000888.

In another embodiment the card holder details can be determined by the following steps:

1. MA receives the PAN from the Merchant when a purchase is made
2. The Account Number and Mobile Phone is stored in MA
3. The issuing bank is identified from the PAN
4. Request is sent from MA to the issuing bank to retrieve the account number associated with this PAN
5. The account number associated with the PAN is returned to MA and MA looks up the mobile number or phone number for that account, for example using FPS
6. The invention sends a notification to the card holder using the issuing bank's default profile in the invention (FPS) to determine if to send SMS, WAP or make IVR call. The system of the invention provides a simple interface for the acquiring bank and the payment service provider to provisioning its merchants. If a merchant wishes to sign up to the service directly a confirmation by its acquirer is needed. Provisioning comprises details such as terminal_id, address, and alert method. A quick and easy plug-and-play installation will minimize deployment time and cost for provisioning the merchant alert of the customers (merchants). Merchant Alert can notify the merchant by any one or more of the following methods: SMS, mail (with link), phone, IVR, webpage, HTTP or SOAP, SMS, IMS. It will be appreciated that the Merchant Alert feature can be integrated with any kind of existing Fraud detection service.

### DEFINITION OF TERMS

Below is a definition of terms used throughout the description.

An Alert—contains the details of a disputed transaction.

The Common Database Store (CDS)—is the database part of the Mobile Application Platform (MAP) architecture used to store global data such as merchant and acquiring bank usernames and passwords.

A Disputed Transaction—is a transaction, considered to be possibly fraudulent, which has been detected in an acquiring banks' fraud detection system.

A Fraud Detection System (FDS)—is an acquiring bank's system that detects transactions considered to be possibly fraudulent.

The information elements—are the individual details of a disputed transaction contained in an alert.

A Merchant System—is a merchant's system that receives and processes disputed transaction alerts forwarded from Merchant Alert.

The Mobile Application Platform (MAP)—is the architectural platform on which Merchant Alert has been developed.

A Notification—is the process of communicating to a merchant that a disputed transaction has occurred.

Transaction Forwarding—is the process of sending a disputed transaction alert to a merchant's system from Merchant Alert.

Fraud Prevention System—FPS.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In this specification the term “credit card” refers to credit cards (MasterCard®, Visa®, Diners Club®, etc.) as well as charge cards (e.g., American Express®, some department store cards), debit cards such as usable at ATMs and many other locations or laser cards or that are associated with a particular account, and hybrids thereof (e.g., to extended payment American Express®, bank debit cards with the Visa® logo, etc.) and should be afforded the widest possible interpretation.

While the foregoing description makes reference to particular illustrative embodiments, these examples should not be construed as limitations. Not only can the inventive system be modified for other card numbered systems; it can also be modified for other computer networks or numbering schemes. Thus, the present invention is not limited to the disclosed embodiments, but is to be accorded the widest scope consistent with the description and/or drawings.

The invention is not limited to the embodiments hereinbefore described but may be varied in both construction and detail.

1. A system for preventing merchant electronic transaction fraud, comprising:
a plurality of network connected data processing terminals, including at least one server;
means for receiving an electronic authorisation request at the server from a first data processing terminal, wherein the request is for authorising the processing of an electronic transaction associated with a cardholder's card data or account data;
means for filtering the received request according to predetermined filtering criteria;
means for identifying at least a second data processing terminal as a merchant device;
means for sending the request to the merchant device, to notify the merchant that processing of an electronic transaction is proposed, a parameter of which is said cardholder's card data or account data and alert data to indicate that the electronic transaction is fraudulent; and
means for receiving interrupt data from the second terminal and for interrupting processing of the, or any further, electronic transaction with that card data or account data.

2. The system of claim 1 comprising means for sending the request to a device associated with the cardholder to notify the card holder that an electronic transaction is about to take place.

3. The system of claim 1 wherein the alert data comprises means for sending instructions to block the electronic transaction received by the server from the card holder to a particular merchant.

4. The system as claimed in claim 1 wherein the first data processing terminal data and the server are connected by a first network, and the second data processing terminal data and the server are connected by the first or a second network.

5. The system as claimed in claim 1 wherein said alert data is transmitted on a unique channel to the merchant, to notify the merchant of a suspected fraudulent transaction.

6. The system as claimed in claim 1 wherein the alert data can be transmitted using a number of different communication protocols, such as HTTP, POST, SMS, WAP or email.

7. The system as claimed in claim 1 comprising means to store inputs from multiple fraud detection systems with previous fraudulent transactions such as those in acquiring banks, card associations, issuing banks, payment service providers or merchants for subsequent comparison with a request for an electronic transaction.

8. The system as claimed in claim 1 wherein the first or second network is selected from the group comprising a public switched telephone network, a cellular telecommunication network, a wide area network, a local area network, a wireless local area network, a virtual private network and an interbank network.

9. The system as claimed in claim 1 wherein the first data processing terminal is selected from the group comprising an electronic point of sale terminal, an electronic card processing terminal, an automatic teller machine, a telephone, a cellular telephone, a radiotelephone, a portable computing device, a desktop computing device.

10. The system as claimed in claim 1 wherein the at least second data processing terminal is selected from the group comprising a telephone, a cellular telephone, a radiotelephone, a pager, a personal digital assistant, a portable computing device, a desktop computing device.

11. The system as claimed in claim 1 wherein the means for identifying the at least second data processing terminal comprises a database storing at least, for each merchant associated with a network address of at least a second data processing terminal.

12. The system according to claim 1, wherein the means for identifying is adapted to identify a plurality of data processing terminals as respective devices of a same merchant.

13. The system according to claim 1, wherein the means for filtering the received request according to predetermined filtering criteria comprises a filter engine, wherein the predetermined filtering criteria is selected from data representative of any one, or a combination, of the group consisting of: a mandatory notification, an optional notification, a transaction amount threshold, a geographical position, a first data processing terminal type, a network type, a financial institution identifier, and a merchant identifier.

14. (canceled)

15. The system according to claim 1, wherein the means for sending the request to the merchant device comprises any one, or a combination, selected from the group comprising messaging instructions stored and processed by the at least one server, a cellular messaging server, an interactive voice response apparatus.

16. The system according to claim 1, wherein the means for receiving interrupt data from the second terminal and interrupting processing of the electronic transaction comprises a combination of at least one selected from the group comprising messaging instructions stored and processed by the at least one server, a cellular messaging server and an interactive voice response apparatus, respectively receiving the interrupt data from the at least second terminal, and a transaction processing terminal.

17. The system according to claim 1, wherein the interrupt data is any one, or a combination, selected from the group comprising a portion of card data, a portion of account data, a personal identification number, alphanumerical data representative of a user decision, digitized audio data representative of a user decision, a predetermined period of time.

18. The system according to claim 1, wherein the plurality of network connected data processing terminals includes at least one security terminal operated by a state, official or private security organisation.

19. The system according to claim 1, wherein the plurality of network connected data processing terminals includes at least one security terminal operated by a state, official or private security organisation and means to automatically communicate interrupt data to the security terminal, whenever interrupt data is received from a second terminal for an electronic transaction and/or the means to automatically communicate further comprises aggregating means for receiving the interrupt data and generating fraud reporting data and/or the fraud reporting data corresponds to at least one selected from the group comprising a geographical position, a first data processing terminal type, a financial institution identifier, a merchant identifier, image data, audio data and video data, as a function of whether any such data is stored at the first data processing terminal and/or at the server in connection with the reported transaction; or the fraud reporting data corresponds to a combination of some or all of data corresponding to a geographical position, a first data processing terminal type, a financial institution identifier, a merchant identifier, image data, audio data and/or video data, as a function of whether any such data is stored at the first data processing terminal and/or at the server in connection with the reported transaction and/or wherein the at least one security terminal is selected from the group consisting of: a telephone, a cellular telephone, a radiotelephone, a pager, a personal digital assistant, a portable computing device, a desktop computing device, a personal radio, a two-way radio, a mobile radio or computing device aboard a land vehicle, aircraft or ship, or a combination thereof.

20-23. (canceled)

24. A system for preventing merchant electronic transaction fraud, comprising:
a plurality of network connected data processing terminals, including at least one server;
means for receiving an electronic authorisation request at the server from a first data processing terminal, wherein the request is for authorising the processing of an electronic transaction associated with a cardholder's card data or account data;
means for filtering the received request according to predetermined filtering criteria;
means for identifying at least a second data processing terminal as a merchant device;
means for sending the request to the merchant device, to notify the merchant that processing of an electronic transaction is proposed, a parameter of which is said cardholder's card data or account data and alert data to indicate that the electronic transaction is fraudulent;
means for sending the request to a device associated with the cardholder to notify the card holder that an electronic transaction is about to take place; and
means for receiving interrupt data from the second terminal and for interrupting processing of the, or any further, electronic transaction with that card data or account data.

25. A method for preventing merchant electronic transaction fraud, comprising:
arranging a plurality of network connected data processing terminals, including at least one server, in a communication network;
receiving an electronic authorisation request at the server from a first data processing terminal, wherein the request is for authorising the processing of an electronic transaction associated with a cardholder's card data or account data;
filtering the received request according to predetermined filtering criteria;
identifying at least a second data processing terminal as a merchant device;
sending the request to the merchant device, to notify the merchant that processing of an electronic transaction is proposed, a parameter of which is said cardholder's card data or account data and alert data to indicate that the electronic transaction is fraudulent; and
receiving interrupt data from the second terminal and for interrupting processing of the, or any further, electronic transaction with that card data or account data.
